(19) United States
(12) Patent Application Publication
(10) Pub. No.: US 2023/0162630 A1
(43) Pub. Date: May 25, 2023

(54) SUPPORTING SHEET ASSEMBLY AND APPARATUS CONFIGURED TO INSTALL SUPPORTING SHEETS

(71) Applicants: Chengdu BOE Optoelectronics Technology Co., Ltd., Chengdu, Sichuan (CN); BOE Technology Group Co., Ltd., Beijing (CN)

(72) Inventors: Kunlong ZHENG, Beijing (CN); Jun REN, Beijing (CN); Xingxing HE, Beijing (CN); Yujun ZHANG, Beijing (CN); Fujian ZHANG, Beijing (CN); Dan ZHU, Beijing (CN)

(21) Appl. No.: 17/912,992

(22) PCT Filed: Feb. 2, 2021
(86) PCT No.: PCT/CN2021/074941

§ 371 Date: Sep. 20, 2022

(30) Foreign Application Priority Data
Mar. 26, 2020 (CN) 202020409707.9

(51) Int. Cl. G09F 9/33

(52) U.S. Cl. CPC G09F 9/33

(57) ABSTRACT

The supporting sheet assembly comprises several supporting sheets. Each supporting sheet includes a supporting sheet body and a nut installed on one side of the supporting sheet body. A protective layer is provided on the side of the supporting sheet body where the nut is installed. An opening is dug in the protective layer at the top part of the nut so as to expose the nut. Along the axis direction of the nut, the height of the protective layer is greater than the height of the nut, which reduces problems such as poor attachment and the generation of air bubbles caused by the difference in force between the position of the nut and the position without the nut on the supporting sheet.

### CROSS REFERENCE TO RELATED APPLICATIONS

The present disclosure is a national phase entry under 35 U.S.C. § 371 of International Application No. PCT/CN2021/074941, filed on Feb. 2, 2021, which claims priority of Chinese Patent Application No. 202020409707.9, filed with the China National Intellectual Property Administration on Mar. 26, 2020 and entitled “Supporting Sheet Assembly and Apparatus Configured to Install Supporting Sheets”, the entire content of which is hereby incorporated by reference.

### FIELD

The present disclosure relates to the field of flexible screens, in particular to a supporting sheet assembly and an apparatus configured to install supporting sheets.

### BACKGROUND

At present, with the development of display technology, considering the bendable characteristics of a flexible AMOLED, the flexible AMOLED can be selected as the material of a folding screen.

The folding screen is the main direction of development of the display technology. Since an external cover of the folding screen is also of a flexible material, the overall strength of the folding screen is insufficient. In order to ensure that the use function of the folding screen is not affected, it is necessary to enhance the strength of the folding screen.

### SUMMARY

The present disclosure discloses a supporting sheet assembly and an apparatus configured to install supporting sheets, so as to enhance the strength of a folding screen.

In order to implement the above objective, the present disclosure provides the following technical solution.

A supporting sheet assembly provided by the present disclosure includes: a plurality of supporting sheets.

The supporting sheet includes a supporting sheet body and a nut installed on a side of the supporting sheet body.

A protective layer is provided on the side of the supporting sheet body where the nut is installed. An opening is dug in the protective layer at a top part of the nut so as to expose the nut.

In an axis direction of the nut, a height of the protective layer is greater than a height of the nut.

Since nut(s) is/are installed on the supporting sheet, the surface of the supporting sheet is uneven. The protective layer is provided on the surface of the supporting sheet where the nut(s) is/are installed. Opening(s) is/are dug in the protective layer so as to expose the nut(s). In the axis direction of the nut, the height of the protective layer is greater than the height of the nut. Therefore, when a screen and a whole machine are attached and fixed, the protective layer is reduced in thickness to be basically on the same plane as the top part(s) of the nut(s). Force at the position(s) of the nut(s) and the position(s) without the nut(s) on the supporting sheet is the same. In the automatic attachment working process of the supporting sheets, the problems such as poor attachment and the generation of air bubbles caused by the difference in force between the position(s) of the nut(s) and the position(s) without the nut(s) on the supporting sheet are relieved. By thickening the protective layer and filling gap(s) between the nut(s) and the screen, the attachment process of the supporting sheets on which the nut(s) is/are installed is achieved. Further, the plurality of supporting sheets are disposed in a stacked manner.

In a possible implementation, an isolation layer is disposed between two adjacent supporting sheets.

In a possible implementation, a thickness of the protective layer is 1.55 mm-1.60 mm.

In a possible implementation, a hardness of the protective layer is 45 Hb-55 Hb.

In a possible implementation, release force of the protective layer is 3 gf-6 gf.

In a possible implementation, the protective layer is made of foam.

An apparatus configured to install supporting sheets further provided by the present disclosure includes: an adsorption assembly for adsorbing the supporting sheets disposed in a stacked manner.

In a possible implementation, the adsorption assembly includes: a film suction plate for contacting protective layers of the supporting sheets. A plurality of vacuum adsorption holes are provided in a side of the film suction plate facing the supporting sheets.

In a possible implementation, the protective layer includes: an opening region on a top part of the nut and a non-opening region.

The vacuum adsorption holes are for contacting the non-opening region.

### BRIEF DESCRIPTION OF THE DRAWINGS

FIG. 1 is a top-view diagram of a supporting sheet provided by an embodiment of the present disclosure.

FIG. 2 is a side-view diagram of a supporting sheet provided by an embodiment of the present disclosure.

FIG. 3 is a side-view diagram of a supporting sheet assembly provided by an embodiment of the present disclosure.

FIG. 4 is a schematic structural diagram of a supporting sheet in an attachment process provided by an embodiment of the present disclosure.

FIG. 5 is a schematic structural diagram of a film suction plate in an apparatus configured to install supporting sheets, and a supporting sheet provided by an embodiment of the present disclosure.

FIG. 6 is a schematic structural diagram of an apparatus configured to install supporting sheets provided by an embodiment of the present disclosure.

### DETAILED DESCRIPTION OF THE EMBODIMENTS

The technical solutions of embodiments of the present disclosure will be described clearly and completely in combination with the accompanying drawings of the embodiments of the present disclosure. Apparently, the described embodiments are some, but not all, embodiments of the present disclosure. Based on the embodiments of the present disclosure, all other embodiments obtained by those of ordinary skill in the art without creative work shall fall within the protection scope of the present disclosure.

A folding screen is the main direction of development of display technology. In order to strengthen the folding screen, supporting sheets with a supporting function are disposed on the back of the folding screen. Because outer glass of the folding screen is made of flexible glass, the supporting sheets configured for support and reinforcement need to be attached to the back of a non-folding region of the folding screen. Considering that assembly of a whole machine needs fixing, nuts need to be attached to the supporting sheets, and the screen and the whole machine are fixed by the nuts.

However, the supporting sheets with the nuts installed have a large gap between the nuts and the supporting sheets, so that in a feeding process, the supporting sheets can only be fed one by one to avoid the nuts installed on the supporting sheets from being damaged by jacking. Meanwhile, in the feeding process, a film suction plate needs to be slotted for receding according to the position and thickness of the nuts, but there will be deviations in the actual feeding, an area of a slotted region needs to be larger than an area of a region occupied by the nut, that is, it is possible that there are two or more nuts in one slotted region, the contact area between the film suction plate and the supporting sheet will be reduced, resulting in a decrease in the suction force of the film suction plate to the supporting sheet, and the supporting sheet is prone to falling off in the feeding.

In an attaching process, since it is necessary to apply an external force to the supporting sheet during attachment to attach the supporting sheet to the screen, in order to avoid damage to the nut(s) on the supporting sheet in the process of applying the external force to the supporting sheet, the process of attaching the supporting sheet in a way of avoiding the nut(s) by a roller is adopted. That is, the external force is applied to the supporting sheet by the roller, and the roller completely avoids the nut(s) on the supporting sheet, so that when the roller applies the external force on the supporting sheet, the nut(s) is/are completely unstressed, and consequently uneven force on the screen is caused and poor mold printing occurs, and problems such as bulging on the front of the attached screen caused by air bubbles after attachment due to incomplete exhaust also exist.

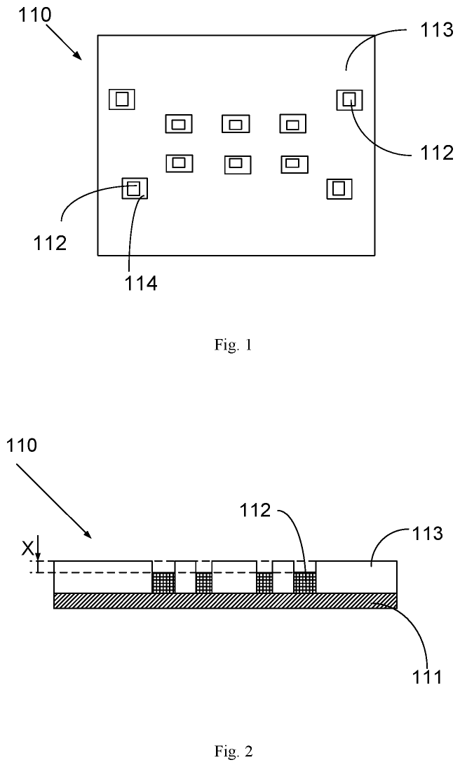

As shown in FIG. 1 and FIG. 2, embodiments of the present disclosure provide a supporting sheet assembly 100, including: a plurality of supporting sheets 110.

The supporting sheet 110 includes: a supporting sheet body 111 and nuts 112 installed on one side of the supporting sheet body 111.

A protective layer 113 is provided on the one side of the supporting sheet body 111 where the nuts 112 are installed. Openings 114 are dug in the protective layer 113 at top parts of the nuts 112 so as to expose the nuts 112.

In an axis direction of each nut 112, a height of the protective layer 113 is greater than a height of the nut 112.

It should be noted that, since the nuts 112 are installed on the supporting sheet 110, the surface of the supporting sheet 110 is uneven. The protective layer 113 is provided on the surface of the supporting sheet 110 where the nuts 112 are installed. The openings are dug in the protective layer so as to expose the nuts. In the axis direction of each nut 112, the height of the protective layer 113 is greater than the height of the nut 112. Therefore, when the screen and a whole machine are attached and fixed, each protective layer is reduced in thickness to be basically on the same plane as the tops of the nuts. Force at the positions of the nuts 112 and the positions without the nuts 112 on each supporting sheet 110 is the same. In the automatic attachment working process of the supporting sheets 110, the problems such as poor attachment and the generation of air bubbles caused by the difference in force between the positions of the nuts 112 and the positions without the nuts 112 on each supporting sheet 110 are reduced. By adoption of thickening the protective layers 113 and filling gaps between the nuts 112 and the screen, the attachment process of the supporting sheets 110 on which the nuts 112 are installed is achieved.

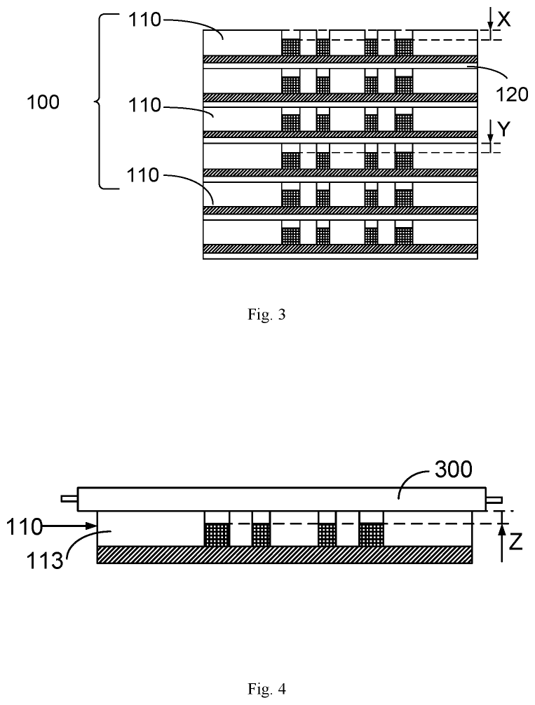

As shown in FIG. 3, since the surface of the supporting sheet 110 with the nuts 112 are uneven and in the feeding process, the supporting sheet with the nuts installed has a large gap between the nuts and the supporting sheet, in the feeding process, the supporting sheets can only be fed one by one, so as to avoid the nuts from being damaged by jacking. This gap will cause the problem of increasing the feeding difficulty. In order to solve the low single-sheet feeding efficiency, the plurality of supporting sheets 110 are disposed in a stacked manner.

When the plurality of supporting sheets 110 are disposed in a stacked manner, considering that the adjacent supporting sheets 110 cannot stick to each other, an isolation layer 120 is disposed between every two adjacent supporting sheets 110 to avoid sticking.

For example, a thickness of each protective layer 113 is designed according to actual needs. The thickness of each protective layer is 1.55 mm-1.6 mm, which may be: 1.55 mm, 1.56 mm, 1.57 mm, 1.58 mm, 1.59 mm or 1.60 mm. A thickness of the nuts on the supporting sheet is 1.45 mm-1.5 mm, e.g.: 1.45 mm, 1.46 mm, 1.47 mm, 1.48 mm, 1.49 mm or 1.50 mm. For example, a height difference between each protective layer 113 and the corresponding nuts 112 is X mm. X may be: 0.05 mm-0.15 mm. X may be for example 0.05 mm, 0.1 mm or 0.15 mm, and the specific value is to be selected according to the actual situation.

For example, a weight of a single supporting sheet 110 is 45 g. In the feeding process stage, in order to solve the problem of low single-sheet feeding efficiency of the supporting sheets, the supporting sheet assembly 100 is fed in a stacked manner. Taking a number 100 of supporting sheets as an example, the stress on the bottommost supporting sheet 110 is about 45 N, and the deformation of the protective layer 113 due to the stress is Y mm. In order to ensure that the laminated sheets are not damaged by the nuts 112 by jacking, X>Y is required.

As shown in FIG. 4, in the attaching process with a roller 300, when a hardness of the roller 300 is 40 Hb and the roller attaching pressure is 0.1 Mpa, the deformation amount of the protective layer 113 is Z mm. In order to ensure that the supporting sheet 110 is stressed evenly to avoid poor mold printing, the deformation amount of the protective layers 113 is Z≈X under the pressure of 0.1 Mpa. To sum up, a value of X is set based on the actual situation of the deformation Y of the protective layer 113 caused by the stress in the feeding process and the deformation amount Z of the protective layer 113 in the attaching process with the roller 300.

In addition, a hardness of the protective layer 113 is 45 Hb-55 Hb, e.g.: 45 Hb, 50 Hb or 55 Hb. Release force of the protective layer 113 is 3 gf-6 gf, e.g.: 3 gf, 4 gf, 5 gf or 6 gf. The hardness of the protective layer 113 is adjusted according to actual needs. The hardness selected above is to ensure that the nuts on the supporting sheets will not be damaged by jacking in the feeding process stage and force at the positions of the nuts 112 and the positions without the nuts 112 on the supporting sheets 110 is the same in the attachment process stage, so that the problems such as poor attachment and the generation of air bubbles caused by the difference in force between the positions of the nuts 112 and the positions without the nuts 112 on the supporting sheets 110 are relieved. By adoption of thickening the protective layers 113 and filling the gaps between the nuts 112 and the screen, the attachment process of the supporting sheets 110 on which the nuts 112 are installed is achieved.

For example, the protective layers 113 are made of foam, and have a series of characteristics such as elasticity, light weight, fast pressure-sensitive fixing, convenient use, free bending, ultra-thin volume, and reliable performance. Thus, the nuts on the supporting sheets are better protected.

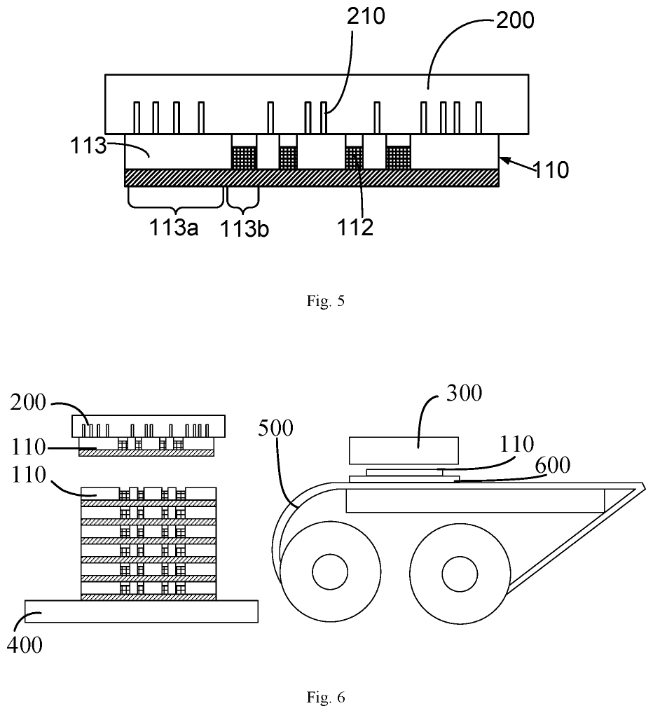

As shown in FIG. 5, an apparatus configured to install supporting sheets further provided by the present disclosure includes: an adsorption assembly for adsorbing the supporting sheets 110 disposed in a stacked manner. The adsorption assembly includes: a film suction plate 200 in contact with protective layers 113 of the supporting sheets 110. A plurality of vacuum adsorption holes 210 are provided in a side of the film suction plate 200 facing the supporting sheets 110. Each protective layer 113 includes: opening region(s) 113b on top part(s) of nut(s) 112 and non-opening region(s) 113a. The vacuum adsorption holes 210 are in contact with the non-opening region(s) 113a. By designing each protective layer 113 according to the positions of the openings, the vacuum adsorption holes 210 are not provided in the opening region(s) 113b so as to prevent the supporting sheets 110 from falling off due to vacuum breaking.

As shown in FIG. 6, the supporting sheets 110 disposed in a stacked manner are transported to the film suction plate 200 in the adsorption assembly by a jacking mechanism 400. The film suction plate 200 adsorbs the supporting sheets 110 disposed in a stacked manner. For example, the jacking mechanism 400 may be any device with a lifting function, such as a cylinder or a hydraulic cylinder.

The adsorption assembly completes the adsorption of the supporting sheet 110 and transfers the supporting sheet 110 to a conveying mechanism 500. For example, the conveying mechanism 500 may be any device with a conveying function such as a belt or a conveying roller, which will not be repeated here. The supporting sheet 110 moves to the attachment process in the movement direction of the conveying mechanism 500. A roller 300 exerts an external force on the supporting sheet 110. The roller 300 completely acts on the protective layer of the supporting sheet 110, so that the roller 300 applies the external force on the protective layer of the supporting sheet 110 to attach the supporting sheet to a screen 600.

Obviously, those skilled in the art can make various modifications and variations to the embodiments of the present disclosure without departing from the spirit and scope of the present disclosure. In this way, if these modifications and variations of the present disclosure fall within the scope of the claims of the present disclosure and equivalent technologies thereof, the present disclosure is also intended to include these modifications and variations.

1. A supporting sheet assembly, comprising:
a plurality of supporting sheets;
wherein the supporting sheet comprises:
a supporting sheet body;
a nut installed on a side of the supporting sheet body; and
a protective layer provided on the side of the supporting sheet body where the nut is installed;
wherein an opening is dug in the protective layer at a top part of the nut so as to expose the nut; and
in an axis direction of the nut, a height of the protective layer is greater than a height of the nut.

2. The supporting sheet assembly according to claim 1, wherein the plurality of supporting sheets are disposed in a stacked manner.

3. The supporting sheet assembly according to claim 2, wherein an isolation layer is disposed between two adjacent supporting sheets.

4. The supporting sheet assembly according to claim 1, wherein a thickness of the protective layer is 1.55 mm-1.60 mm.

5. The supporting sheet assembly according to claim 1, wherein a hardness of the protective layer is 45 Hb-55 Hb.

6. The supporting sheet assembly according to claim 1, wherein release force of the protective layer is 3 gf-6 gf.

7. The supporting sheet assembly according to claim 1, wherein the protective layer is made of foam.

8. An apparatus configured to install supporting sheets, comprising:
an adsorption assembly for adsorbing the supporting sheets disposed in a stacked manner.

9. The apparatus configured to install the supporting sheets according to claim 8, wherein the adsorption assembly comprises:
a film suction plate for contacting protective layers of the supporting sheets;
wherein a plurality of vacuum adsorption holes are provided in a side of the film suction plate facing the supporting sheets.

10. The apparatus configured to install the supporting sheets according to claim 9, wherein the protective layer comprises:
an opening region on a top part of a nut; and
a non-opening region;
wherein the vacuum adsorption holes are for contacting the non-opening region.
